(19) United States
(12) Patent Application Publication
(10) Pub. No.: US 2025/0165644 A1
(43) Pub. Date: May 22, 2025

(54) METHOD FOR DISPLAYING INFORMATION INSIDE A VEHICLE WITH PRIVACY CONSIDERATIONS, AND AN APPARATUS FOR IMPLEMENTING THE SAME

(71) Applicant: HYUNDAI AUTOEVER CORP., Seoul (KR)

(72) Inventors: Won Heung Jo, Seoul (KR); Hee Eun Lee, Seoul (KR); Esther Choi, Seoul (KR); Joo Ho Chae, Seoul (KR); Il Kyun Kim, Seoul (KR); Min Jeong Kim, Seoul (KR); Yeon Kyung Chung, Seoul (KR); Ji Young Han, Seoul (KR); Rak Jun Sung, Seoul (KR); Hwa Hyeon Hong, Seoul (KR)

(73) Assignee: HYUNDAI AUTOEVER CORP., Seoul (KR)

(21) Appl. No.: 18/953,541

(22) Filed: Nov. 20, 2024

(30) Foreign Application Priority Data
Nov. 22, 2023 (KR) 10-2023-0162950

(51) Int. Cl. G06F 21/62

(52) U.S. Cl. CPC G06F 21/6245

(57) ABSTRACT

A method for displaying information inside a vehicle with privacy considerations includes, in response to detecting that a passenger is onboard the vehicle in addition to a vehicle owner, calculating an intimacy score based on a predefined condition between the vehicle owner and the passenger. The method also includes determining a range of information disclosure inside the vehicle based on the intimacy score, thereby providing only information corresponding to the range of information disclosure determined based on the intimacy score.

### CROSS-REFERENCE TO RELATED APPLICATION

This application claims the benefit of and priority to Korean Patent Application No. 10-2023-0162950, filed on Nov. 22, 2023, the entire contents of which are incorporated herein by reference.

### FIELD OF TECHNOLOGY

The present disclosure relates to a method for displaying information inside a vehicle with privacy considerations and an apparatus for implementing the same.

### BACKGROUND

The statements in this section merely provide background information related to the present disclosure and may not constitute prior art.

Recently, automobiles have evolved beyond mere means of transportation to spaces that offer not only diverse information and content but also advanced, convenient, and user-friendly features.

Particularly with the advancement of autonomous driving technologies, there is growing interest in vehicle infotainment systems, which integrate information needed for driving and navigation with various entertainment and user-friendly features.

Vehicle infotainment systems typically include functions such as Global Positioning System (GPS) navigation, audio and video features, and the ability to connect smartphones via Bluetooth or Universal Serial Bus (USB), allowing access to all personal information stored on users' smartphones.

While these features of the vehicle infotainment systems are highly convenient for performing various tasks simultaneously while driving, such features pose a risk of exposing drivers' sensitive personal information when passengers are present.

Additionally, the information provided through the vehicle infotainment systems is typically not restricted based on the relationship between the drivers and the passengers.

### SUMMARY

Aspects of the present disclosure provide a method for displaying information inside a vehicle with privacy considerations and an apparatus for implementing the same, that offer a modified screen interface to prevent the vehicle owner's sensitive personal information from being exposed when passengers are present.

Aspects of the present disclosure also provide a method for displaying information inside a vehicle with privacy considerations and an apparatus for implementing the same, that restrict the exposure of personal information at various levels based on the social intimacy between the vehicle owner and the passengers.

Aspects of the present disclosure also provide a method for displaying information inside a vehicle with privacy considerations and an apparatus for implementing the same, that temporarily display personal information in the area gazed upon by the vehicle owner, even when passengers are present and personal information exposure is restricted.

However, aspects of the present disclosure are not restricted to those set forth herein. The above and other aspects of the present disclosure should become more apparent to one of ordinary skill in the art to which the present disclosure pertains by referencing the detailed description of the present disclosure below.

According to an aspect of the present disclosure, a method for displaying information inside a vehicle with privacy considerations is performed by a computing device provided in the vehicle. The method includes, in response to detecting that a passenger is onboard the vehicle in addition to the vehicle owner, calculating an intimacy score based on a predefined condition between the vehicle owner and the passenger. The method also includes determining a range of information disclosure inside the vehicle based on the calculated intimacy score, thereby providing only information corresponding to the determined range of information disclosure.

In some embodiments, calculating the intimacy score may include detecting the presence of the passenger using touch sensors or door open detection sensors provided on external handles of the vehicle.

In some embodiments, calculating the intimacy score may include recognizing a face area of the passenger from an image captured by photographing the passenger, and calculating the intimacy score based on a number of photographs stored on the vehicle owner's terminal that include a face recognized as identical to the face area of the passenger.

In some embodiments, calculating the intimacy score may include calculating the intimacy score using contact information and social network service (SNS) information stored on terminals of the vehicle owner and the passenger.

In some embodiments, determining the range of information disclosure may include blinding all information displayed inside the vehicle when the intimacy score is below a predetermined threshold.

In some embodiments, determining the range of information disclosure may include blinding only predefined highest-priority information among all information displayed inside the vehicle when the intimacy score is above a predetermined threshold.

In some embodiments, blinding only the highest-priority information may include blinding the vehicle owner's financial information and personal messages to prevent them from being displayed.

In some embodiments, the computing device may be a display device provided in the vehicle or a server communicating with the vehicle.

According to another aspect of the present disclosure, a method for displaying information inside a vehicle with privacy considerations, performed by a computing device provided in the vehicle, is provided. The method includes, in response to detecting that a passenger is onboard the vehicle in addition to the vehicle owner, entering privacy mode that blinds predetermined important information displayed on the vehicle's internal display. The method also includes, in the privacy mode, performing iris recognition of the vehicle owner and releasing the blinding of the important information displayed in an area of the display corresponding to the vehicle owner's gaze direction.

In some embodiments, entering the privacy mode may include detecting the presence of the passenger using touch sensors or door open detection sensors provided on the external handles of the vehicle.

In some embodiments, entering the privacy mode may include obtaining an intimacy score between the vehicle owner and the passenger based on a predefined condition, and displaying only information corresponding to a range of information disclosure determined based on the intimacy score, and blinding information that does not fall within the determined range of information disclosure.

In some embodiments, obtaining the intimacy score may include recognizing a face area of the passenger from an image captured by photographing the passenger, and obtaining the intimacy score based on a number of photographs stored on the vehicle owner's terminal that include a face recognized as identical to the face area of the passenger.

In some embodiments, obtaining the intimacy score may include obtaining the intimacy score using contact information and social network service (SNS) information stored on terminals of the vehicle owner and the passenger.

In some embodiments, the method may further include terminating the privacy mode when the passenger is no longer detected based on the weight sensing of seats inside the vehicle.

In some embodiments, releasing the blinding of the important information may include detecting that the vehicle owner is seated in a seat other than the driver's seat, and performing iris recognition of the vehicle owner seated in the seat other than the driver's seat and releasing the blinding of the important information displayed in the area corresponding to the vehicle owner's gaze direction.

According to yet another aspect of the present disclosure, a computing device is provided. The computing device comprises at least one processor, a communication interface communicating with an external device, a memory loading a computer program executed by the at least one processor, and a storage storing the computer program. The computer program includes instructions for performing operations of, in response to detecting that a passenger is onboard a vehicle in addition to the vehicle owner, calculating an intimacy score based on a predefined condition between the vehicle owner and the passenger, and determining a range of information disclosure inside the vehicle based on the calculated intimacy score, thereby providing only information corresponding to the determined range of information disclosure.

In some embodiments, calculating the intimacy score may include detecting the presence of the passenger using touch sensors or door open detection sensors provided on external handles of the vehicle.

In some embodiments, calculating the intimacy score may include recognizing a face area of the passenger from an image captured by photographing the passenger, and calculating the intimacy score based on a number of photographs stored on the vehicle owner's terminal that include a face recognized as identical to the face area of the passenger.

In some embodiments, calculating the intimacy score may include calculating the intimacy score using contact information and social network service (SNS) information stored on terminals of the vehicle owner and the passenger.

In some embodiments, determining the range of information disclosure may include blinding all information displayed inside the vehicle when the intimacy score is below a predetermined threshold.

It should be noted that the effects of the present disclosure are not limited to those described above, and other effects of the present disclosure should be more apparent to one of ordinary skill in the art from the following description.

### BRIEF DESCRIPTION OF THE DRAWINGS

The above and other aspects and features of the present disclosure should become more apparent from the following detailed description with reference to the accompanying drawings, in which:

FIG. 1 illustrates a configuration of a system according to an embodiment of the present disclosure;

FIG. 2 is a flowchart for explaining a method for displaying information inside a vehicle with privacy considerations according to an embodiment of the present disclosure;

FIGS. 3 and 4 are detailed flowcharts for explaining some steps illustrated in FIG. 2 according to embodiments of the present disclosure;

FIG. 5 is a flowchart for explaining a method for displaying information inside a vehicle with privacy considerations according to an embodiment of the present disclosure;

FIG. 6 is a detailed flowchart for explaining some steps illustrated in FIG. 5 according to an embodiment of the present disclosure;

FIG. 7 is a flowchart for explaining an additional step performed after the steps illustrated in FIG. 5 according to an embodiment of the present disclosure;

FIG. 8 illustrates an example of calculating an intimacy score between a vehicle owner and a passenger through facial recognition according to some embodiments of the present disclosure;

FIG. 9 illustrates an example of calculating an intimacy score between a vehicle owner and a passenger using contact and social network service (SNS) information according to some embodiments of the present disclosure;

FIG. 10 illustrates an example of determining the range of information disclosure based on an intimacy score according to some embodiments of the present disclosure;

FIG. 11 illustrates an example of blinding some information upon entering privacy mode according to some embodiments of the present disclosure;

FIG. 12 illustrates an example of releasing the blinding of some information through iris recognition of a vehicle owner according to some embodiments of the present disclosure; and

FIG. 13 is a hardware configuration diagram of an example computing device capable of implementing the methods according to embodiments of the present disclosure.

### DETAILED DESCRIPTION

Hereinafter, embodiments of the present disclosure are described in detail with reference to the accompanying drawings. The advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided to make this disclosure thorough and complete and to fully convey the concept of the present disclosure to those having ordinary skill in the art, and the present disclosure should only be defined by the appended claims.

In adding reference numerals to the components of each drawing, it should be noted that the same reference numerals are assigned to the same components as much as possible even when the components are shown in different drawings. In addition, in describing the present disclosure, when it has been determined that the detailed description of the related well-known configuration or function may obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless the terms are specifically defined clearly herein. The terminology used herein is for the purpose of describing particular embodiments only and is not intended to be limiting of the present disclosure. In this specification, the singular also includes the plural unless specifically stated otherwise in the present disclosure.

In addition, in describing the component of the present disclosure, terms such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with the other component, but it should be understood that another component also may be “connected,” “coupled” or “contacted” between the component and the other component.

When a component, device, module, element, or the like of the present disclosure is described as having a purpose or performing an operation, function, or the like, the component, device, or element should be considered herein as being “configured to” meet that purpose or perform that operation or function.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure are described in detail with reference to the accompanying drawings.

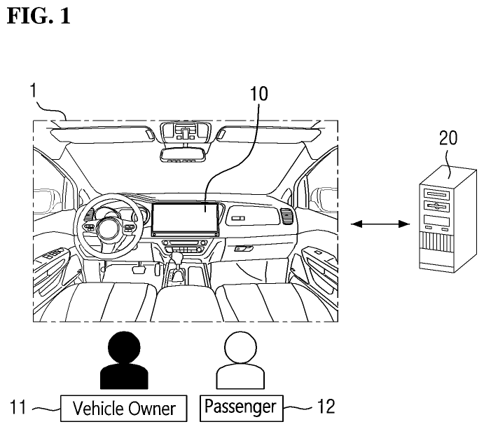

FIG. 1 illustrates a configuration of a system according to an embodiment of the present disclosure.

Referring to FIG. 1, the system includes a display device 10 provided inside a vehicle 1. The system also includes a server 20. The display device 10 is connected to the server 20 through a network.

The display device 10 provided inside the vehicle 1 may be an infotainment terminal and offers various information necessary for driving and various content that the driver can enjoy.

For example, the display device 10 may perform various functions such as navigation for driving and route guidance, content playback for video and audio, internet browsing for searching information online, and smartphone connectivity for mirroring the smartphone screen.

The display device 10 may be mounted at the front between the driver's seat and the passenger seat within the vehicle 1, but the present disclosure is not limited thereto. The display device 10 may be installed anywhere inside the vehicle 1 to provide information to a vehicle owner 11 and a passenger 12 through the screen.

The server 20 provides information requested by the display device 10 in the vehicle 1 and may collect and store data generated by a user from the display device 10.

For example, the server 20 may be a navigation server providing road information and route search information necessary for the navigation function of the display device 10. Additionally, the server 20 may be a search server providing search results based on search terms requested by the display device 10. The server 20 may also collect and store information and operation history generated by operations by the vehicle owner 11 on the display device 10.

When the vehicle owner 11 and the passenger 12 are present inside the vehicle 1, the display device 10 may display requested information by the vehicle owner 11, in which case there is a risk of exposing sensitive personal information in addition to general content and route search information.

Therefore, the display device 10 may perform the following privacy protection function to prevent exposure of sensitive personal information of the vehicle owner 11.

First, when the vehicle owner 11 and the passenger 12 are both present in the vehicle 1, the display device 10 may sense the presence of the passenger 12 using sensing data received from touch sensors on external handles or door open detection sensors provided in the vehicle 1.

When the presence of the passenger 12 is detected, the display device 10 may calculate a social intimacy score between the vehicle owner 11 and the passenger 12.

For example, the display device 10 may perform facial recognition on the passenger 12 and may calculate the social intimacy score using the number of recognized faces in the smartphone photo album of the vehicle owner 11 that match facial image of the passenger 12 obtained through facial recognition.

In another example, the display device 10 may compare the contact information and social network service (SNS) information stored on the smartphones of the vehicle owner 11 and the passenger 12 and may calculate the social intimacy score based on the ratio of overlapping information.

The social intimacy score may be calculated directly by the display device 10 inside the vehicle 1, but the present disclosure is not limited thereto. Alternatively, the social intimacy score may also be calculated by the server 20 connected to the display device 10 and may then be transmitted to the display device 10.

The display device 10 may determine the range of information to be displayed on the screen based on the social intimacy score calculated between the vehicle owner 11 and the passenger 12.

Accordingly, the display device 10 may control the screen interface to display only information corresponding to the determined range and may thus prevent the display of information outside the determined range. For example, the display device 10 may apply a blind process to hide information that does not fall within the determined range from all the information displayed on the screen.

In one embodiment, when iris recognition is performed on the iris of the vehicle owner 11 through a camera sensor provided in the vehicle 1, the display device 10 may release the blind process for the area of the screen corresponding to a direction of gaze (sometimes referred to herein as “gaze direction”) of the vehicle owner 11 identified by the iris recognition. Accordingly, even if sensitive personal information of the vehicle owner 11 is hidden through the blind process, the display device 10 may release the blind process for the screen area where the gaze of the vehicle owner 11 is directed, allowing the personal information of the vehicle owner 11 to be exposed only to the vehicle owner 11.

According to the configuration of the system, a modified screen interface that prevents the exposure of the vehicle owner's sensitive personal information when passengers are present can be provided. Additionally, the exposure of personal information can be restricted at various levels based on the social intimacy between the vehicle owner and the passengers.

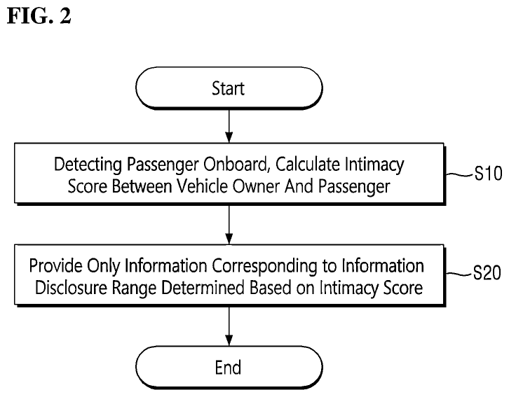

FIG. 2 is a flowchart for explaining a method for displaying information inside a vehicle with privacy considerations according to an embodiment of the present disclosure.

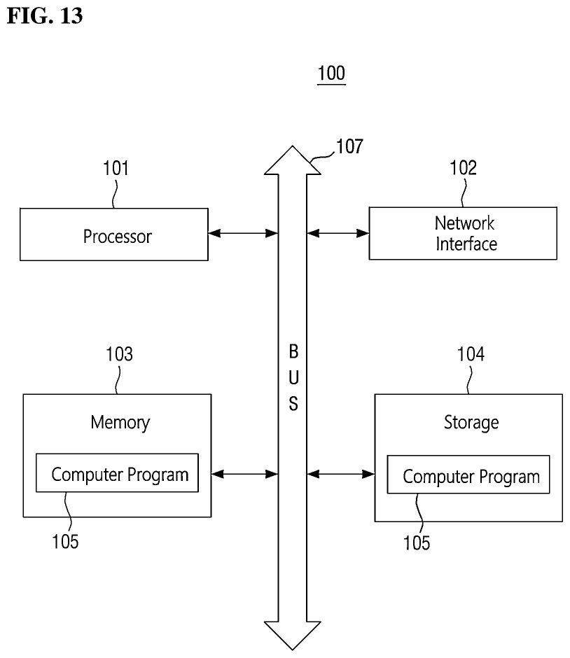

The method of FIG. 2 may be executed by the display device 10 or the server 20 of FIG. 1. The display device 10 or the server 20 executing the method of FIG. 2 may be a computing device 100 illustrated in FIG. 13.

The description of the subject of some operations or steps included in the method of FIG. 2 may be omitted, and in such cases, it should be noted that the subject is the computing device 100.

According to an embodiment, when passengers other than the vehicle owner are onboard, the exposure of the vehicle owner's sensitive personal information may be restricted at various levels based on the social intimacy between the vehicle owner and the passengers.

Referring to FIG. 2, in a step or operation S10, in response to detecting the vehicle owner 11 and the passenger 12 are both onboard, the computing device 100 calculates an intimacy score based on a predefined condition between the vehicle owner 11 and the passenger 12.

The computing device 100 may detect the presence of the passenger 12 using sensing data received from the touch sensors on the external handles or the door open detection sensors provided in the vehicle 1.

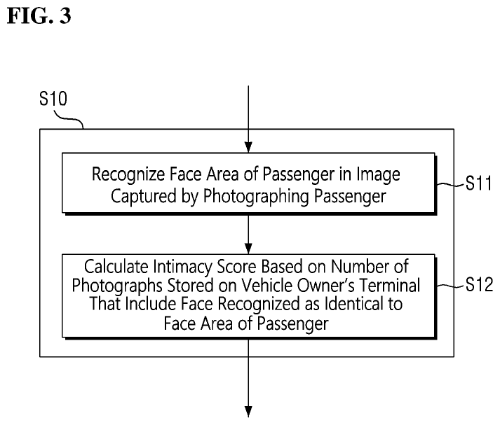

In one embodiment, referring to FIG. 3, the step or operation S10 includes a step or operation S11, in which the face area of the passenger 12 is recognized from an image captured by photographing the passenger 12. The step or operation S10 also includes a step S12, in which the intimacy score is calculated based on the number of photographs stored on the terminal of the vehicle owner 11 that contain the face recognized in the step or operation S11.

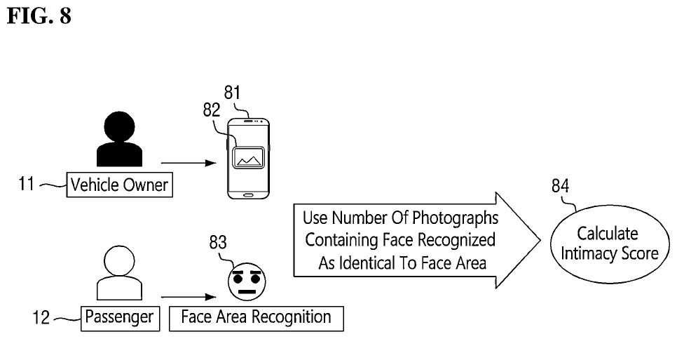

For example, as illustrated in FIG. 8, the computing device 100 may capture an image of the passenger 12 by using a camera sensor provided inside the vehicle 1 or attached to the computing device 100, and may recognize the face area of the passenger 12 within the obtained image. Here, a machine learning-based object recognition algorithm may be applied to recognize a face area 83 of the passenger 12 in the captured image.

In the example of FIG. 8, the computing device 100 may extract the number of photographs in a photo album 82 stored on a smartphone 81 of the vehicle owner 11 that include the face recognized as identical to the face area 83 of the passenger 12. The computing device 100 may calculate an intimacy score 84 between the vehicle owner 11 and the passenger 12 using the number of extracted photographs. For example, if the intimacy score 84 ranges from 0 to 5, an intimacy score 84 of 5 is assigned when the number of extracted photographs is 30 or more; an intimacy score 84 of 4 is assigned when the number of extracted photographs is between 20 and 30; an intimacy score 84 of 3 is assigned when the number of extracted photographs is between 10 and 20; an intimacy score 84 of 2 is assigned when the number of extracted photographs is between 5 and 10; an intimacy score 84 of 1 is assigned if the number of extracted photographs is between 1 and 5; and the lowest intimacy score 84 of 0 is assigned if the number of extracted photographs is zero.

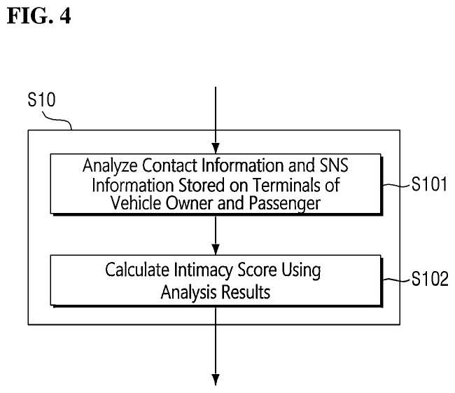

In one embodiment, referring to FIG. 4, the step or operation S10 includes a step or operation S101, in which the contact information and SNS information stored on the terminals of the vehicle owner 11 and the passenger 12 are analyzed. The step or operation S10 also includes a step or operation S102, in which the intimacy score is calculated based on the results of the analysis performed in the step or operation S101.

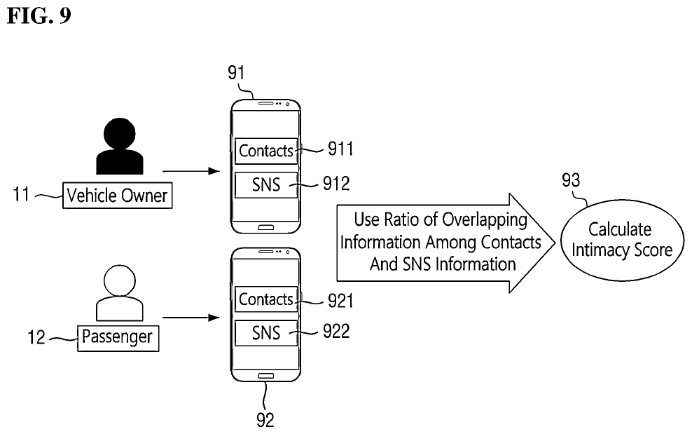

For example, as illustrated in FIG. 9, the computing device 100 may calculate an intimacy score 93 using contact information 911 and SNS information 912 stored on a smartphone 91 of the vehicle owner 11 and contact information 921 and SNS information 922 stored on a smartphone 92 of the passenger 12.

In the example of FIG. 9, the computing device 100 may extract the ratio of overlapping contacts between the contact information 911 stored on the smartphone 91 of the vehicle owner 11 and the contact information 921 stored on the smartphone 92 of the passenger 12. The computing device 100 may assign a higher intimacy score 93 for a higher ratio of overlapping contacts, and a lower intimacy score 93 for a lower ratio of overlapping contacts.

Additionally, the computing device 100 may extract the ratio of overlapping information between the SNS information 922 corresponding to the account of the passenger 12 and the SNS information 911 corresponding to the account of the vehicle owner 11. The higher the ratio of overlapping information, the higher the intimacy score 93 assigned, and the lower the ratio of overlapping information, the lower the intimacy score 93 assigned.

Referring again to FIG. 2, in a step or operation S20, the computing device 100 may determine the range of information disclosure inside the vehicle 1 based on the intimacy score calculated between the vehicle owner 11 and the passenger 12 in the step or operation S10. Accordingly, the computing device 100 may provide only the information corresponding to the determined information disclosure range.

In one embodiment, if the intimacy score is below a predetermined threshold, the computing device 100 may blind all information displayed inside the vehicle 1.

Additionally, if the intimacy score is above the predetermined threshold, the computing device 100 may blind only predefined highest-priority information among all information displayed inside the vehicle 1. For example, the highest-priority information may be financial information and personal messages of the vehicle owner 11, which may be blinded not to be displayed.

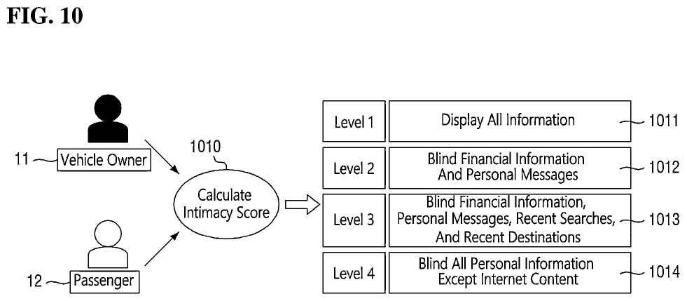

In one embodiment, referring to FIG. 10, the computing device 100 may set the information disclosure range to multiple levels based on an intimacy score 1010 calculated between the vehicle owner 11 and the passenger 12.

As illustrated in FIG. 10, the multiple levels set based on the intimacy score 1010 may include Level 1 (1011) for displaying all information, Level 2 (1012) for blinding financial information and personal messages of the vehicle owner 11, Level 3 (1013) for blinding financial information, personal messages, recent search content, and recent destinations of the vehicle owner 11, and Level 4 (1014) for blinding all personal information of the vehicle owner 11 except internet content.

For example, if the intimacy score 1010 ranges from 1 to 100, the computing device 100 may display all information corresponding to Level 1 (1011) when the intimacy score 1010 is 90 or above. If the intimacy score 1010 is between 80 and 90, the computing device 100 may display information corresponding to Level 2 (1012) (excluding financial information and personal messages). If the intimacy score 1010 is between 50 and 80, the computing device 100 may display the information corresponding to Level 3 (1013) (excluding financial information, personal messages, recent search content, and recent destinations). If the intimacy score 1010 is below 50, the computing device 100 may display only the information corresponding to Level 4 (1014) (internet content).

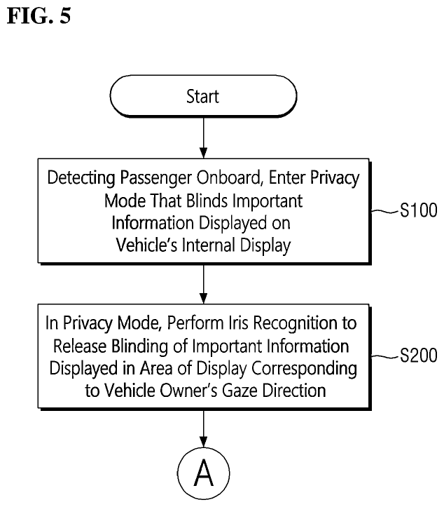

FIG. 5 is a flowchart for explaining a method for displaying information inside a vehicle with privacy considerations according to an embodiment of the present disclosure.

The method of FIG. 5 may be executed by the display device 10 of FIG. 1. The display device 10 executing the method of FIG. 5 may be the computing device 100 of FIG. 13.

The description of the subject of some operations or steps included in the method of FIG. 5 may be omitted, and in such cases, it should be noted that the subject is the computing device 100.

Referring to FIG. 5, in a step or operation S100, in response to detecting that the vehicle owner 11 and the passenger 12 are both onboard, the computing device 100 enters privacy mode that blinds predetermined important information displayed on the vehicle 1's internal display. Here, the computing device 100 may detect the presence of the passenger 12 using the touch sensors on the external handles or the door open detection sensors provided in the vehicle 1.

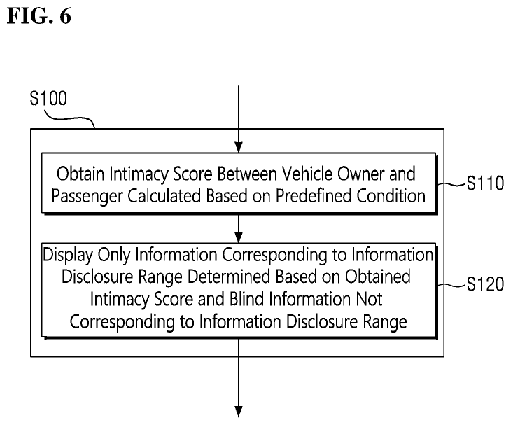

In one embodiment, referring to FIG. 6, step S100 may include steps or operations S110 and S120.

In the step or operation S110, the computing device 100 obtains an intimacy score calculated between the vehicle owner 11 and the passenger 12 based on a predetermined condition. In the step or operation S120, the computing device 100 displays only information corresponding to an information disclosure range determined based on the intimacy score and blinds information outside the determined information disclosure range.

In one embodiment, in the step or operation S110, the computing device 100 may recognize the face area of the passenger 12 from an image captured by photographing the passenger 12 and may obtain an intimacy score calculated based on the number of photographs stored on the terminal of the vehicle owner 11 that include the face recognized as identical to face area of the passenger 12.

Additionally, in the step or operation S110, the computing device 100 may also obtain an intimacy score calculated using the contact information and SNS information stored on the terminals of the vehicle owner 11 and the passenger 12. For example, the intimacy score may be calculated based on the ratio of overlapping information between the contact information and SNS information stored on the terminal of the passenger 12 and those stored on the terminal of the vehicle owner 11.

Referring again to FIG. 5, in a step or operation S200, in the privacy mode, the computing device 100 performs iris recognition of the vehicle owner 11 and releases the blinding of the important information displayed in the area of the display corresponding to the direction of gaze of the vehicle owner 11. The operation of releasing the blinding of the important information displayed in the area corresponding to the direction of gaze of the vehicle owner 11 may also be applicable even when the vehicle owner 11 is detected to be seated in a seat other than the driver's seat.

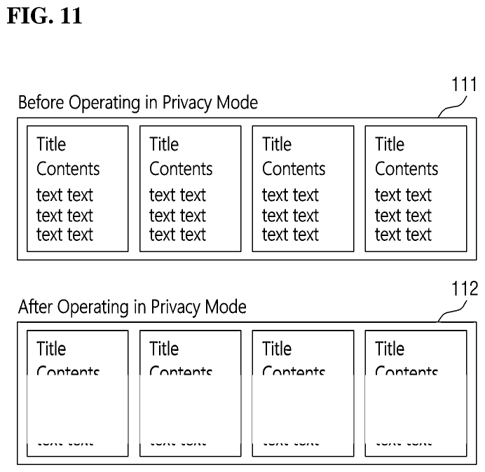

For example, referring to FIG. 11, in an operation 111 before the computing device 100 operates in, or enters the privacy mode, the computing device 100 may display both general content and important information including the personal information of the vehicle owner 11.

When the presence of the passenger 12 is detected, the computing device 100 operates in, or enters the privacy mode in an operation 112. Then, important information predefined by the vehicle owner 11 is blinded, allowing only other general content to be displayed. Here, the important information may include, for example, personal information such as financial information, personal messages, contacts, and address book.

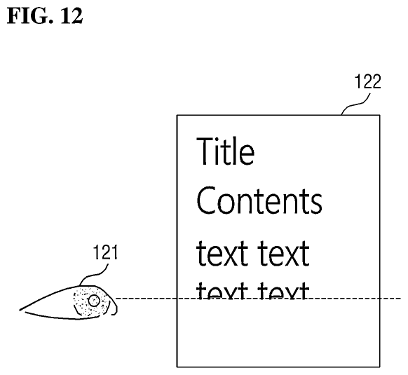

In one embodiment, referring to FIG. 12, after entering privacy mode in the operation 112 and blinding the important information as in the example of FIG. 11, the computing device 100 may perform iris recognition of the vehicle owner 11 and may release the blinding of important information for the display area corresponding to the gaze direction 121 of the vehicle owner 11, as illustrated in a block 122 in FIG. 12.

Accordingly, sensitive personal information may be temporarily exposed in the display area where the gaze of the vehicle owner 11 is directed, and when the gaze of the vehicle owner 11 moves elsewhere, the temporarily exposed personal information may be blinded again, allowing personal information in the display area to which the gaze has moved to be temporarily exposed.

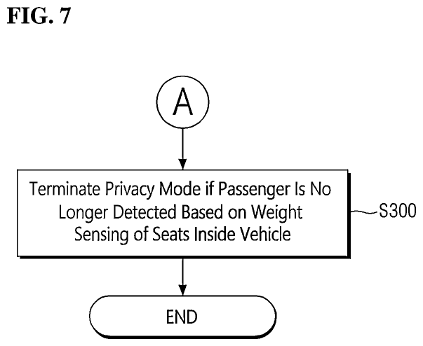

In one embodiment, referring to FIG. 7, after performing the steps or operations S100 and S200 of FIG. 5, a step or operation S300 may be additionally performed.

In the step or operation S300, the computing device 100 may terminate the privacy mode if the passenger 12 is no longer detected based on the weight sensing of the seats inside the vehicle 1.

For example, weight measurement sensors that can measure the weight of the seats inside the vehicle 1 are attached to the seats in the vehicle 1, and by monitoring the weight measured by the weight measurement sensors, it may be determined whether the passenger 12 who was seated has left the vehicle 1. For example, if the weight measured by the weight measurement sensors is below a predetermined threshold, it may be determined that the passenger 12 is no longer seated. In this case, the computing device 100 may terminate the privacy mode by releasing the blinding of the important information that has been blinded in the privacy mode and may display all the important information normally.

According to the embodiments of the present disclosure, when a passenger other than the vehicle owner is onboard, a modified screen interface can be provided to prevent the exposure of the vehicle owner's sensitive personal information, and even if the exposure of personal information is restricted, the vehicle owner can temporarily view personal information in the area where their gaze is directed, allowing the vehicle owner to momentarily check necessary personal information even when there are passengers onboard.

FIG. 13 is a hardware configuration diagram of an example computing device 100 according to an embodiment of the present disclosure.

Referring to FIG. 13, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

In one embodiment, a computer program 105 may include instructions for performing the operations of: in response to detecting that a passenger is onboard a vehicle in addition to the vehicle owner, calculating an intimacy score based on a predefined condition between the vehicle owner and the passenger; and determining the range of information disclosure inside the vehicle based on the calculated intimacy score, thereby providing only information corresponding to the determined information disclosure range.

In an embodiment, the computer program 105 may include instructions for performing the operations of: entering privacy mode that blinds predefined important information displayed inside a vehicle in response to detecting that a passenger is onboard the vehicle in addition to the vehicle owner; and releasing the blinding of the important information displayed in the vehicle owner's gaze direction by performing iris recognition of the vehicle owner in the privacy mode.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained only when the operations are performed in the specific order or sequential order or only when all of the operations are performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications may be made to the described embodiments without departing from the principles of the present disclosure. Therefore, the disclosed embodiments are used in a generic and descriptive sense only and not for purposes of limitation.

What is claimed is:

1. A method for displaying information inside a vehicle with privacy considerations, the method comprising:
in response to detecting that a passenger is onboard the vehicle in addition to a vehicle owner, calculating, by a computing device, an intimacy score based on a predefined condition between the vehicle owner and the passenger; and
determining, by the computing device, a range of information disclosure inside the vehicle based on the intimacy score, thereby providing only information corresponding to the range of information disclosure determined based on the intimacy score.

2. The method of claim 1, wherein calculating the intimacy score includes calculating the intimacy score in response to detecting that the passenger is onboard the vehicle using touch sensors and/or door open detection sensors provided on external handles of the vehicle.

3. The method of claim 1, wherein calculating the intimacy score includes:
recognizing a face area of the passenger from an image captured by photographing the passenger; and
calculating the intimacy score based on a number of photographs, stored on a terminal of the vehicle owner, that include a face recognized as identical to the face area of the passenger.

4. The method of claim 1, wherein calculating the intimacy score includes calculating the intimacy score using contact information and social network service (SNS) information stored on terminals of the vehicle owner and the passenger.

5. The method of claim 1, wherein determining the range of information disclosure includes blinding all information displayed inside the vehicle when the intimacy score is below a predetermined threshold.

6. The method of claim 1, wherein determining the range of information disclosure includes blinding only predefined highest-priority information among all information displayed inside the vehicle when the intimacy score is above a predetermined threshold.

7. The method of claim 6, wherein blinding only predefined highest-priority information includes blinding financial information of the vehicle owner and personal messages of the vehicle owner to prevent the financial information and the personal messages from being displayed.

8. The method of claim 1, wherein the computing device is a display device provided in the vehicle or a server communicating with the vehicle.

9. A method for displaying information inside a vehicle with privacy considerations, the method comprising:
in response to detecting that a passenger is onboard the vehicle in addition to a vehicle owner, entering, by a computing device, privacy mode that blinds predetermined important information displayed on an internal display of the vehicle; and
in the privacy mode, performing, by the computing device, iris recognition of the vehicle owner and releasing, by the computing device, blinding of the predetermined important information displayed in an area of the internal display corresponding to a direction of gaze of the vehicle owner.

10. The method of claim 9, wherein entering the privacy mode includes entering the privacy mode in response to detecting that the passenger is onboard the vehicle using touch sensors and/or door open detection sensors provided on external handles of the vehicle.

11. The method of claim 9, wherein entering the privacy mode includes:
obtaining an intimacy score between the vehicle owner and the passenger based on a predefined condition; and
displaying only information corresponding to a range of information disclosure determined based on the intimacy score and blinding information that does not fall within the range of information disclosure determined based on the intimacy score.

12. The method of claim 11, wherein obtaining the intimacy score includes:
recognizing a face area of the passenger from an image captured by photographing the passenger; and
obtaining the intimacy score based on a number of photographs, stored on a terminal of the vehicle owner, that include a face recognized as identical to the face area of the passenger.

13. The method of claim 11, wherein obtaining the intimacy score includes obtaining the intimacy score using contact information and social network service (SNS) information stored on terminals of the vehicle owner and the passenger.

14. The method of claim 9, further comprising terminating the privacy mode when the passenger is no longer detected based on weight sensing of seats inside the vehicle.

15. The method of claim 9, wherein releasing blinding of the predetermined important information includes
detecting that the vehicle owner is seated in a seat other than a driver seat; and
performing iris recognition of the vehicle owner seated in the seat other than the driver seat and releasing the blinding of the predetermined important information displayed in the area corresponding to a direction of gaze of the vehicle owner.

16. A computing device comprising:
at least one processor;
a communication interface communicating with an external device; and
a memory storing a computer program,
wherein the computer program, when executed by the at least one processor, causes the at least one processor to perform operations including:
in response to detecting that a passenger is onboard a vehicle in addition to a vehicle owner, calculating an intimacy score based on a predefined condition between the vehicle owner and the passenger, and
determining a range of information disclosure inside the vehicle based on the intimacy score, thereby providing only information corresponding to the range of information disclosure determined based on the intimacy score.

17. The computing device of claim 16, wherein calculating the intimacy score includes calculating the intimacy score in response to detecting that the passenger is onboard the vehicle using touch sensors and/or door open detection sensors provided on external handles of the vehicle.

18. The computing device of claim 16, wherein calculating the intimacy score includes:
recognizing a face area of the passenger from an image captured by photographing the passenger; and
calculating the intimacy score based on a number of photographs, stored on a terminal of the vehicle owner, that include a face recognized as identical to the face area of the passenger.

19. The computing device of claim 16, wherein calculating the intimacy score includes calculating the intimacy score using contact information and social network service (SNS) information stored on terminals of the vehicle owner and the passenger.

20. The computing device of claim 16, wherein determining the range of information disclosure includes blinding all information displayed inside the vehicle when the intimacy score is below a predetermined threshold.
